(19) United States
(12) Patent Application Publication
(10) Pub. No.: US 2007/0069496 A1
(43) Pub. Date: Mar. 29, 2007

(54) Torsion beam suspension member

(76) Inventors: Ronald A. Rinehart, Stevens, PA (US); William J. Kroppe, Wyomissing, PA (US); Scott Librock, St. Catharines (CA)

Correspondence Address: LINIAK, BERENATO & WHITE, Suite 240, 6550 Rock Spring Drive, Bethesda, MD, 20817, US

(21) Appl. No.: 11/235,665

(22) Filed: Sep. 27, 2005

(51) Int. Cl. B60G 11/20; B60B 35/00; B21D 53/88

(52) U.S. Cl. 280/124.166; 280/124.106; 29/897.2; 301/127

(57) ABSTRACT

A torsion beam suspension member using two u-shaped, stamped members that are superimposed and welded to form a torsion arm. No additional torsion tube or bar is needed. Tuning holes (rectangular, oblong, round or any other suitable shape) are used to change or tune the torsional resilience of the suspension. In the preferred embodiment, the tuning holes are oblong and located near the center of the cross member. The tuning holes are selected based on having target value for torsional compliance or resilience. The size, quantity and location of the tuning hole are chosen based on computer analysis. An optimization or iterative process is used to arrive at the final hole size, quantity and location.

### BACKGROUND OF THE INVENTION

1. Field of the Invention

The present invention generally relates to suspensions used for a vehicle and the like and, more particularly, to a twist beam type suspension having a twist beam provided between left and right trailing arms.

2. Description of the Related Art

A twist beam type suspension is known which has a twist beam bridging between left and right control arms. The left and right trailing arms are pivotally supported on a vehicle body at their front ends. The twisted beam is formed substantially in a straight shape and connected at opposite ends to the respective left and right control arms. The twist beam is resistant to bending but resilient relative to torsional stress.

The control arms along their rearward ends typically have connected thereto a spring seat. The spring seat is provided on the control arm to support a suspension coil spring which is disposed between the vehicle body and the control arm. A shock absorber having one end attached to the control arm and a second end attached to the vehicle body is usually mounted near the coil spring. Depending upon the structure of the control arms, a transversely oriented track bar may or may not be placed between the control arm and the vehicle body to laterally stabilize the axle assembly. Depending on the desired torsional stiffness of the axle assembly, the axle assembly may or may not have a transversely extending stabilizer bar disposed within or in close proximity to the twist beam.

Each control arm has connected thereto a spindle mounting plate. The spindle mounting plate can be part of the spring seat or can be optionally located elsewhere, separate from the spring seat. A spindle assembly is mounted to each of the spindle mounting plates. Each spindle assembly typically includes a spindle and a unitary flange for mounting to the spindle mounting plates. The spindle is fixed relative to the spindle mounting plate. A wheel bearing is disposed over the spindle. A rotating brake element such as a brake drum or brake disk turns on a wheel bearing mounted on the spindle by way of the wheel bearing. A wheel is mounted to the brake elements for unitary rotation therewith.

Twist-beam axles, in particular a twist-beam rear axles, combine the advantages of a single structure with slight specific gravity and good kinematic properties.

Various proposals have been made to so configure the transverse strut of a twist-beam rear axle as to be rigid on one side and to provide sufficiently low degree of torsional stiffness on the other side. Manufacture of these transverse struts is, however, very complex so that production costs of a complete twist-beam axle are increased.

The adjustment of the tilt of the automobile body can be attained by adjusting the torsional rigidity of the torsion beam. The torsion beam type suspension, therefore, may well be regarded as a suspension which has a stabilizer integrated with an axle serving the purpose of positioning the laterally opposite wheels.

The stabilizer effect of the torsion beam has an impact on the suspension of its own, depending on the characterizing features of the relevant automobile. For the purpose of adjusting this stabilizer effect, it is desirable to alter suitably the torsional rigidity of the torsion beam depending to the kind of automobile.

It would therefore be desirable and advantageous to provide an improved twist-beam axle to obviate prior art shortcomings and to meet the increasing demand for better performance and adjustability as well as longer service life of twist-beam axles, while yet reducing costs at the same time.

### SUMMARY OF THE INVENTION

A torsion beam suspension member adapted to rotatably support laterally opposite wheels comprises a first stamped plate defining a substantially u-shaped portion in cross section; and a second stamped plate defining a substantially u-shaped member in cross section, where the first and second stamped plates are mated to enclose a hollow part therebetween. A weld joint joins the lower end of one of the plates to a joining part of the other plate. The second plate is formed with a spring seat portion at each lateral end thereof.

The torsion beam suspension member further comprises at least one aperture formed in at least one of the first and second plates along an axis of the suspension member, whereby the aperture is sized to tune a torsion characteristic of the suspension member.

A method of forming a torsion beam suspension members, comprises the steps of: stamping a first plate member with a first u-shaped beam portion; stamping a second plate member with a second u-shaped beam portion; super-imposing the first and second plate members to enclosed a hollow portion therebetween; welding joining portions of the first and second plate members to join the members into a unitary body. The steps of stamping the first and second plate members comprise forming a spring seat portion in at least one of the first and second plate members. Further, apertures are formed in at least one of the first and second plate members to tune a torsional characteristic of the unitary body.

These and other aspects of the present invention will be apparent to those of skill in the art when viewed in light of the following drawings and associated description.

### BRIEF DESCRIPTION OF THE DRAWINGS

FIG. 1 shows one embodiment of torsion beam suspension member according to the present invention.

FIG. 2 is a front view of the torsion beam suspension member of FIG. 1.

FIG. 3 is a side view of the torsion beam suspension member of FIG. 1.

FIG. 4 is an exploded view of a torsion beam suspension member with no tuning holes.

FIG. 5A is a front view of a torsion beam suspension member similar to FIG. 4 with no tuning holes.

FIG. 5B is a top view of the torsion beam suspension member of FIG. 5A.

FIG. 5C is a sectional view of the torsion beam suspension member of FIG. 5B taken along line VC-VC.

FIGS. 6A-6F show different cross sectional configurations for the central portion of the torsion beam taken along the section line VI-VI shown in FIG. 5A.

FIGS. 7A and 7B show different cross sectional configurations for the spring seat portion of the torsion beam taken along the section line VII-VII shown in FIG. 5A.

FIG. 8 shows yet another design for a torsion beam where the upper and lower stampings are welded together.

FIG. 9 shows the design of FIG. 8 with a tuning hole added to adjust the torsional characteristics of the torsion beam.

### DETAILED DESCRIPTION OF PREFERRED EMBODIMENTS

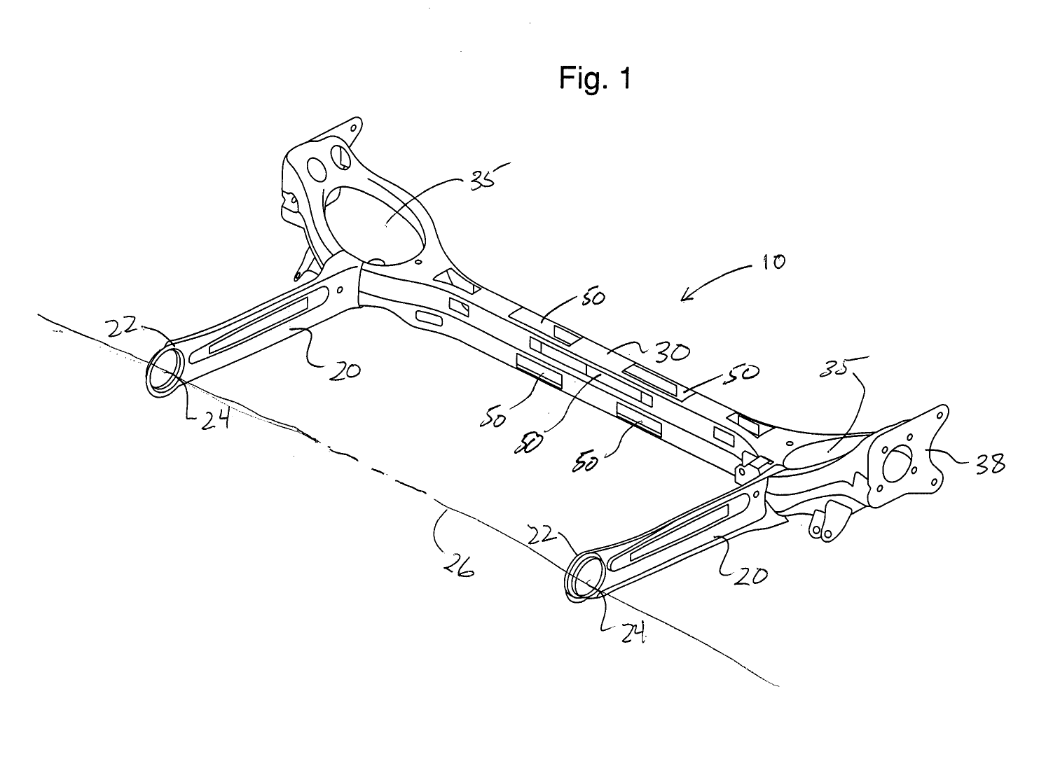

FIG. 1 shows one preferred embodiment of the present invention whereby the twist axle assembly 10 is adapted to be mounted to the underside of a vehicle body (not shown) at a pair of pivot points defined by bushings (not shown). The bushings are typically disposed at a forward or leading end 22 of the control arms 20 in circular bushing apertures 24. The control arms 20 typically extend rearward from the bushing apertures 24. The control arms 20 extend generally parallel to the longitudinal axis of the vehicle and are generally parallel spaced from one another. The bushings define an axle assembly pivot axis 26 about which the axle assembly pivots after being mounted in the vehicle body.

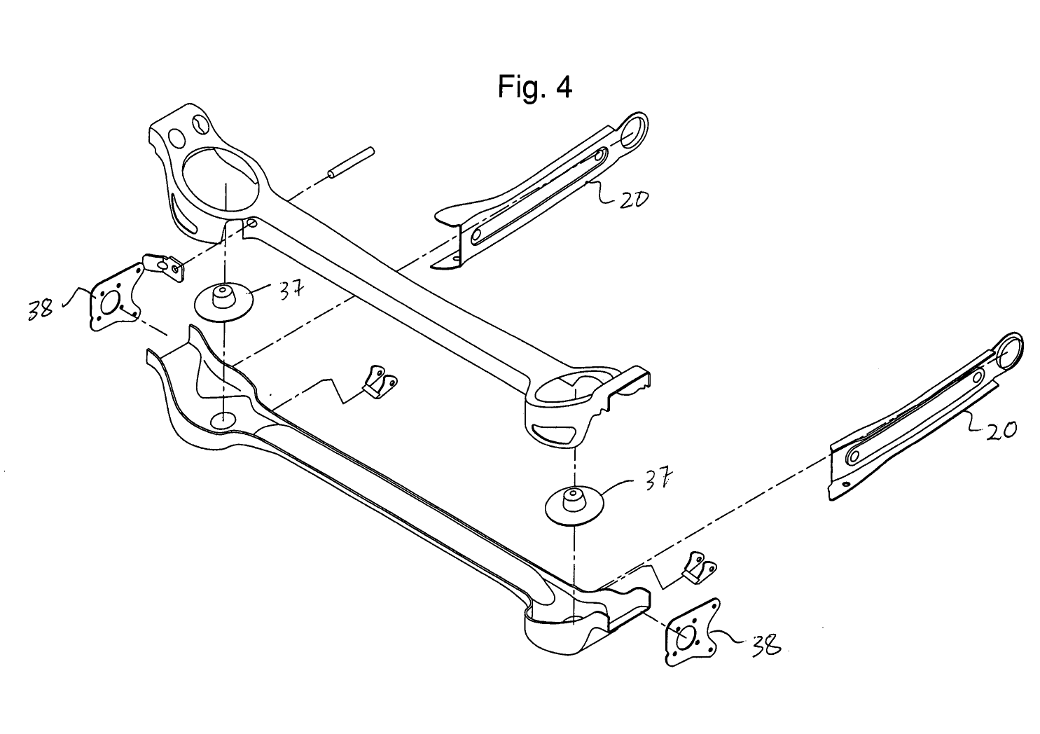

The transverse twist beam axle 30 connects the control arms 20. The twist beam axle 30 extends generally parallel to pivot axis 26 and transverse to the longitudinal axis of the vehicle. A spring seat 35 is provided adjacent the intersection area of the twist beam 30 and the control arms 20 to support a suspension coil spring (not shown) disposed between the vehicle body and the spring seat 35. A spring mount 37 (see FIG. 4) laterally stabilizes the coil spring. A shock absorber (not shown) has one end attached to the control arms 20 and a second end attached to the vehicle body. Depending on the structure of the control arms 20, a transversely oriented track bar may or may not be placed between the axle assembly and the vehicle body to laterally stabilize the axle assembly 10. Depending on the desired torsional stiffness of the axle assembly 10, the axle assembly 10 may or may not have a transversely extending stabilizer bar disposed within or in close proximity to the twist beam 30. The stabilizer bar, if employed, can be of a desired torsional stiffness established by vehicle design criteria.

As shown in FIGS. 1-4, each side of the axle 10 has a spindle mounting plate 38. Although the spindle mounting plates 38 are shown in the accompanying figures at the ends of a transverse beam 30, they may be located at different positions separate from the spring seats. A spindle assembly (not shown), which includes a spindle, a spindle axis and a wheel bearing, is mounted to each of the spindle plates 38. A rotative brake element (not shown), such as a brake drum or brake disc, is in turn rotatably mounted to the spindle through the wheel bearing. A wheel (not shown) is also mounted to the rotative brake element for rotation about the spindle. Because the wheels are indirectly mounted to the spindle plates 38, the spindle plates 38 must be set at the desired alignment angles for the vehicle rear suspension. Also, features on the spindle plates 38 which locate the spindle assemblies thereon must be aligned so that, when mounted, the spindles are axially aligned with each other. The location of the axis of alignment between the spindles is virtually parallel to the pivot axis 26 of the axle assembly as defined by the sleeves of the bushings, so as to aid in ensuring wheel alignment.

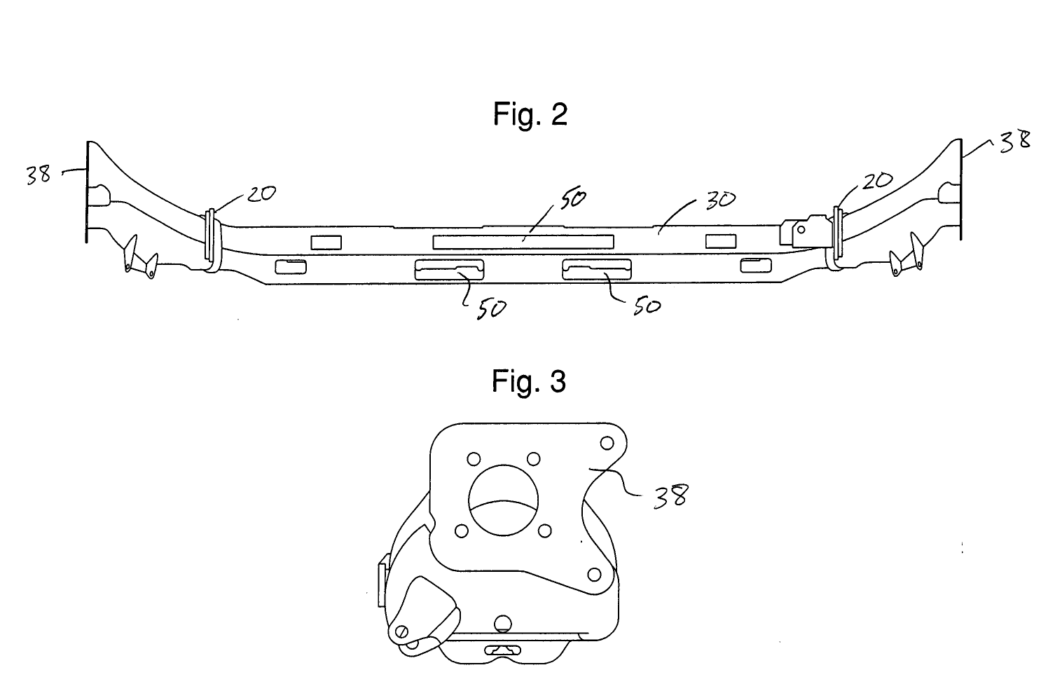

FIG. 2 is a front view of the torsion twist beam axle 30 according to this invention with substantially the same shape as the axle shown in FIG. 1. FIG. 3 is a side view of the axle of FIG. 2.

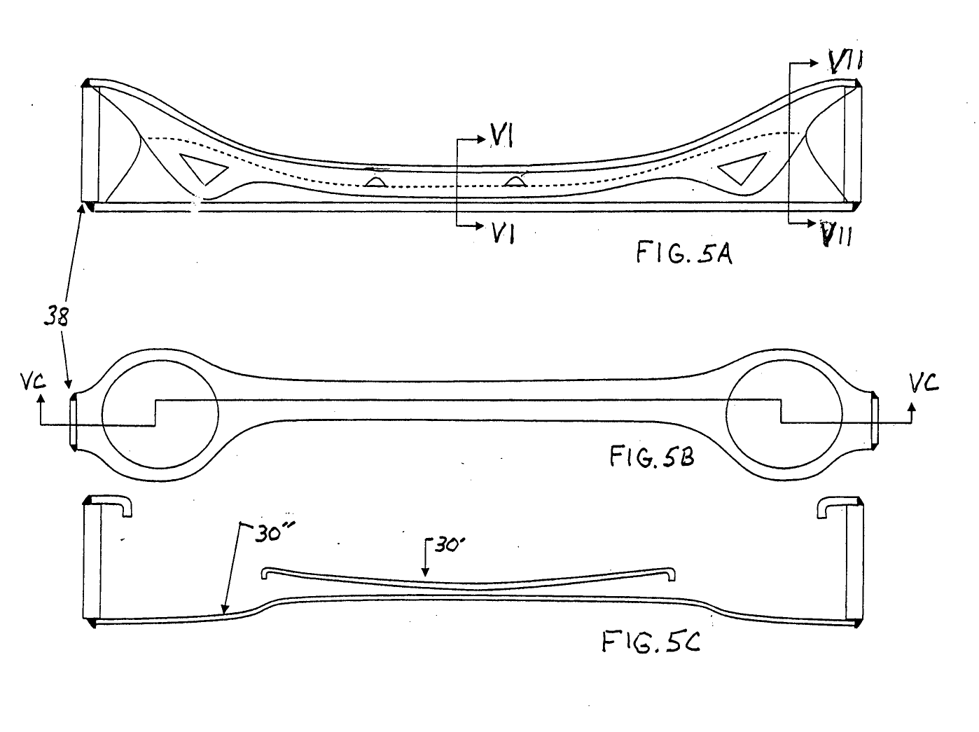

FIGS. 5A shows the torsion beam 30 from a front view. FIG. 5B is a top view of the torsion beam 30. FIGS. 5C is a sectional view of the torsion beam 30 taken along section line VC-VC of FIG. 5B.

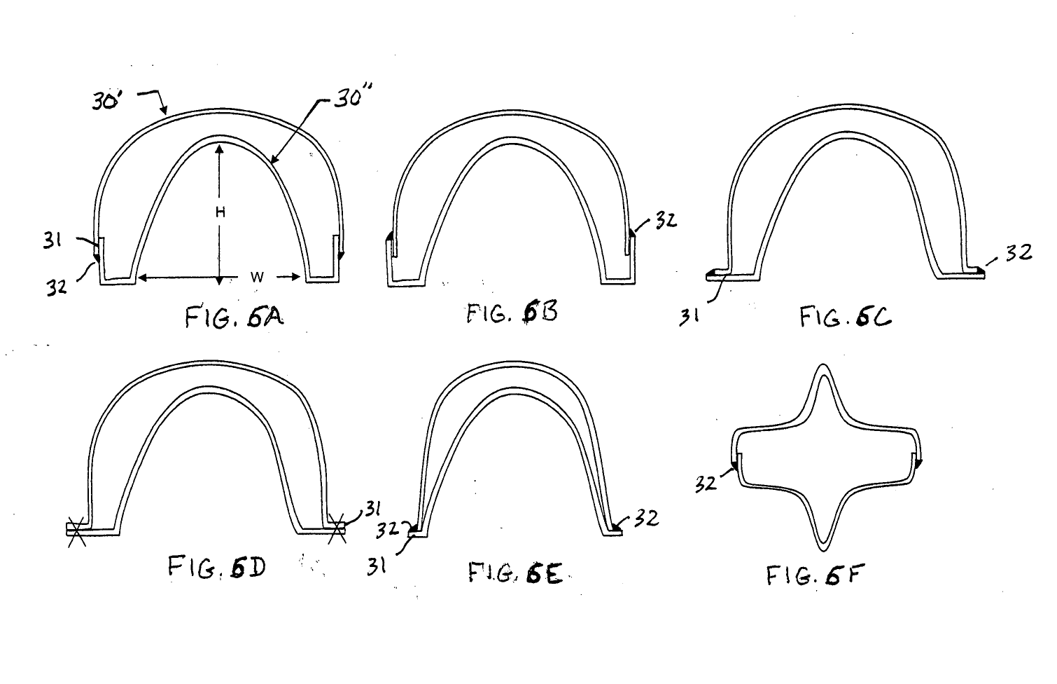

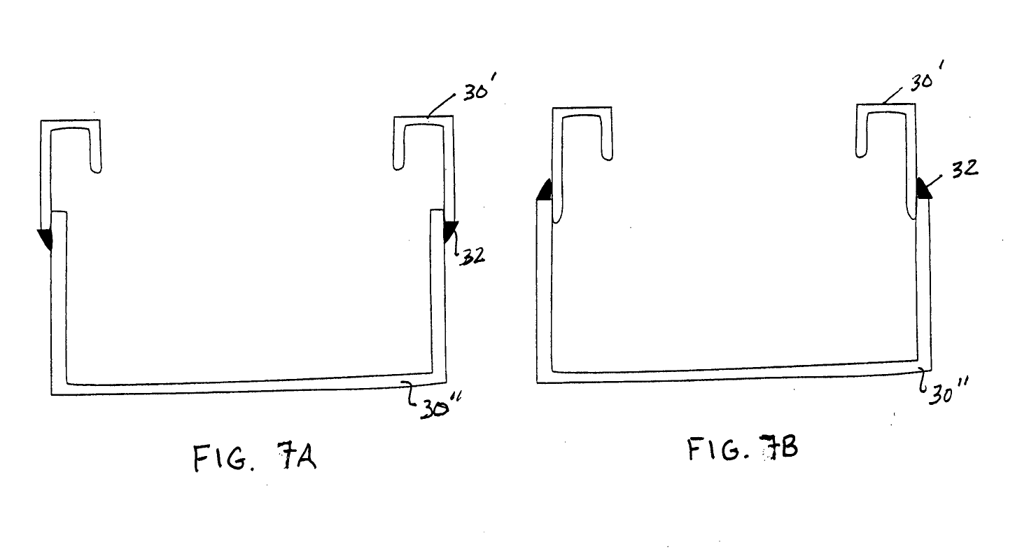

FIGS. 6A-6F show different cross sectional configurations for the central portion of the torsion twist beam 30 of FIG. 5A taken along the section line VI-VI shown in FIG. 5A. For each design shown in FIGS. 6A-6F, the torsion twist beam 30 is formed of two super-imposed members 30′, 30″ that are welded together at abutting or overlapping portions 31 for the superimposed members 30′, 30″. Reference 32 denotes the weld section. It is particularly noted that the upper member 30′ and the lower member 30″ are stamped to define the desired u-shaped portions with the predetermined height (H) and width (W) dimensions. Joining feet 31 are appropriately formed to facilitate welding or other suitable connection of the upper and lower members as shown in FIGS. 6A-6F.

In the embodiments of FIGS. 6A-6C & 6E-6F, a gas metal arc weld is preferred to join the upper and lower members 30′, 30″; whereas the joining feet shown in FIG. 6D are preferably welded using a resistance spot weld technique.

FIGS. 7A and 7B show different cross sectional configurations for the spring seat portion of the torsion twist beam 30 of FIG. 5A taken along the section line VII-VII shown in FIG. 5A. Again the upper and lower members 30′, 30″ are welded at weld sections 32.

According to the foregoing embodiment of the present invention, the transverse strut may have over a major portion of its length an inverted U-shaped cross section. In this way, the dynamic stability can be improved while reducing the weight of the rear axle. This measure realizes an improvement of the running behavior, in particular of the camber change and lane change in behavior of the twist-beam rear axle during negotiation of bumps, turns and curves. Suitably, the transverse strut is made of a hollow profile and cross section of high degree of torsional stiffness, whereas a mid-section of the transverse strut has a U-shaped double-walled cross section of low degree of torsional stiffness. The transitions from the cross section of high degree of torsional stiffness to the cross section of low degree of torsional stiffness are selected based on desired torsional characteristics. In this way, forces in the transverse strut are better distributed.

This invention further provides a unique method of forming the upper and lower members 30′, 30″ defining the torsion beam 30. Specifically, this invention provides a method of tuning the torsional characteristics of the torsion beam using tuning holes 50 disposed in the torsion beam 30 shown in FIGS. 1 and 2. During the design process, which typically takes places with the aid of computer aided design techniques, the torsion beam is designed with no tuning holes to calculate baseline torsion values, then holes are added to adjust torsional characteristics of the torsion beam.

FIG. 4 shows an example of the original torsion beam with no tuning holes. A computer analysis is conducted on the torsion beam design of FIG. 4 to determine that, for an analytical mass of 28.64 kg, and an R Z Right of −96.87 N and an R X Left of 96.87 N; the torsional stiffness is 2190 N-m/Deg.

FIG. 1 shows the same torsion beam as illustrated in FIG. 4 with tuning holes 50 added to adjust and tune to torsional characteristics of the torsion beam 30. A computer analysis of the torsion beam 30 shown in FIG. 1 reveals that the torsional stiffness is reduced to 352 N-m/Deg for an analytical mass of 25.18 kg and an R Z Right of −15.57 N and an R Z Left of 15.57 N. Therefore, the tuning holes 50 achieve a desired tuning of the torsional stiffness from 2190 N-m/Deg to 352 N-m/Deg in accordance with a desired property base on the vehicle at issue, which is known to the torsion beam designer.

The following chart shows a variety of torsion beam designs with different characteristics, including the designs of FIGS. 1 and 4.

With Bush

| | | | Torsional |
|---|---|---|---|
| | | Analytical | Stiffness |
| Model | | Mass (kg) | N-m/Deg |
| P0832aa | Upr 3.8, Lwr 4.0 | 28.64 | 2190 |
| Ref Axle | | 32.52 | 347 |
| P0832aa1 | | 28.64 | 2093 |
| P0832aa2 | | 27.98 | 1011 |
| P0832aa3 | | 27.60 | 994 |
| P0832aa31 | Upr 3.8, Lwr 3.8 | 27.05 | 967 |
| P0832aa4 | Upr 3.8, Lwr 3.8 | 26.34 | 565 |
| P0832aa5 | Upr 3.8, Lwr 3.8 | 25.85 | 452 |
| P0832aa51 | Upr 3.6, Lwr 3.8 | 25.44 | 440 |
| P0832aa6 | Upr 3.6, Lwr 3.8 | 25.18 | 352 |
| P0832aa66 | Upr 3.8, Lwr 4.0 | 26.07 | 385 |

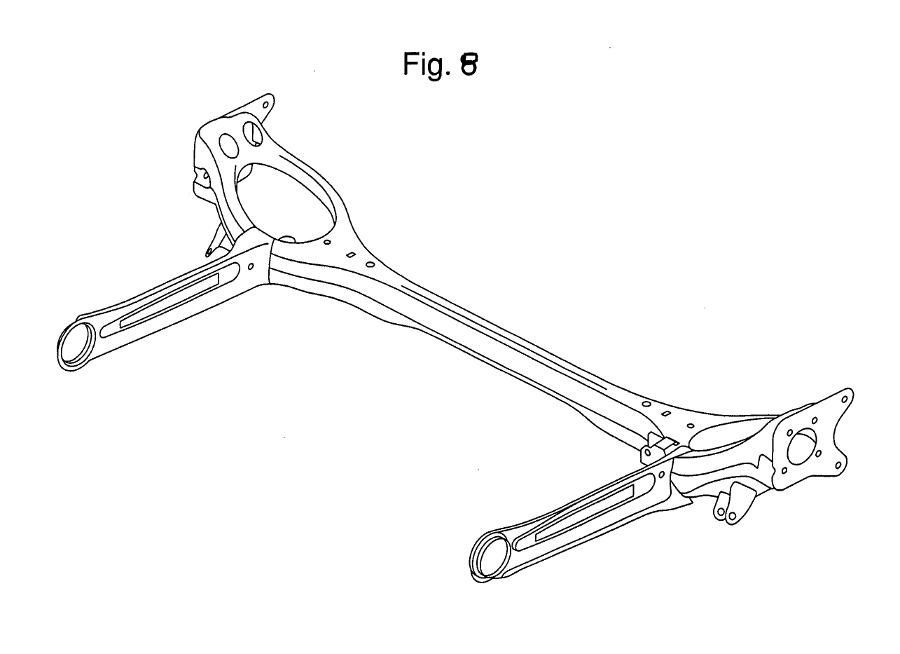

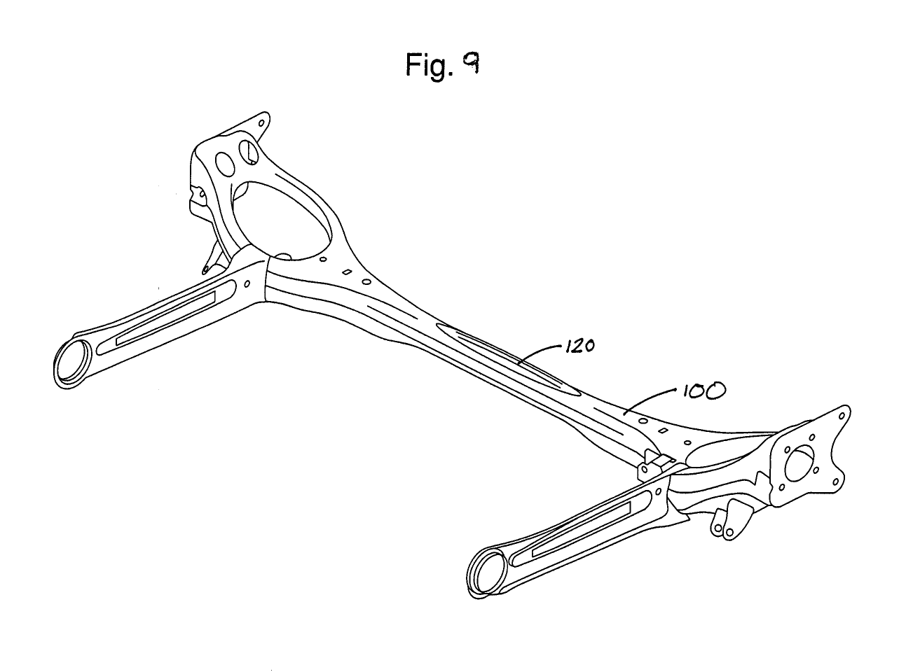

FIG. 8 shows yet another design for a torsion beam where the upper and lower stampings are welded together fully with no skips in the weld seam and the lower section is raised in the middle portion by about 5 mm. For the torsion beam of FIG. 8 with a mass of 27.23 kg, the torsional stiffness is calculated to be 922 N-m/deg using computer aided analysis. When a tuning aperture 120 is added to the upper stamping 100, the mass is reduced to 26.39 kg and the torsional stiffness is lowered to 752 N-m/deg. Thus, the impact of the tuning aperture 120 lowers the torsional stiffness from 922 to 753 N-m/deg.

Based on the foregoing description, it is clear that the invention is a torsion twist axle using two u-shaped, stamped members that are superimposed and welded to form a torsion arm. No additional torsion tube or bar is needed. Notably, the invention uses holes (rectangular, oblong, round or any other suitable shape) to change or tune the torsional resilience of the suspension. In the preferred embodiment, the tuning holes are oblong and located near the center of the cross member.

The tuning holes are selected based on having target value for torsional compliance or resilience. The size, quantity and location of the tuning hole are chosen based on computer analysis. An optimization or iterative process is used to arrive at the final hole size, quantity and location.

While the foregoing invention has been shown and described with respect to the preferred embodiments, it will be understood by those of skill in the art that various changes in form and detail may be made therein without departing from the spirit and scope of the claimed invention.

1. A torsion beam suspension member adapted to rotatably support laterally opposite wheels, said torsion beam comprising:
a first stamped plate defining a substantially u-shaped portion in cross section;
a second stamped plate defining a substantially u-shaped member in cross section, said first and second stamped plates adapted to enclose a hollow area therebetween,
a weld joint joining the lower end of one of said plates to a joining part of the other plate, and
a spring seat portion formed at each lateral end of said second plate.

2. The torsion beam suspension member according to claim 1, further comprising at least one aperture formed in at least one of said first and second plates along an axis of said suspension member, said aperture being sized to tune a torsion characteristic of said suspension member.

3. The torsion beam suspension member according to claim 1, further comprising spindle plates affixed to each lateral end of the torsion beam suspension member, said spindle plates being formed to a mount a spindle, a spindle axis and a wheel bearing for said opposite wheels.

4. The torsion beam suspension member according to claim 1, further comprising a spring mount disposed at said spring seat portion between said first and second stamped plates.

5. The torsion beam suspension member according to claim 1, further comprising at least one control arm mounted to said torsion beam suspension member adjacent said spring eat portion.

6. A method of forming a torsion beam suspension members, comprising the steps of:
stamping a first plate member with a first u-shaped beam portion;
stamping a second plate member with a second u-shaped beam portion;
super-imposing said first and second plate members to enclosed a hollow area therebetween;
welding joining portions of said first and second plate members to join said members into a unitary body.

7. The method according to claim 6, wherein said steps of stamping said first and second plate members comprise forming a spring seat portion in at least one of said first and second plate members.

8. The method according to claim 6, further comprising the step of forming apertures in at least one of said first and second plate members to tune a torsional characteristic of said unitary body.

9. The method according to claim 8, wherein said at least one aperture is formed in one plate member disposed on top of the other plate member.

10. The method according to claim 8, wherein said at least one aperture is disposed at a central region of said at least one first and second plate members.
